(19) United States
(12) Patent Application Publication
(10) Pub. No.: US 2009/0161850 A1
(43) Pub. Date: Jun. 25, 2009

(54) EFFICIENT MECHANISM FOR THE MANAGEMENT OF CALL/SESSION EVENT INFORMATION FOR NEAR REAL-TIME CAUSAL ANALYSIS

(75) Inventors: David Raymer, Watauga, TX (US); Walter Johnson, Hoffman Estate, IL (US); Barry Menich, South Barrington, IL (US)

Correspondence Address: FLEIT, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 11/962,686

(22) Filed: Dec. 21, 2007

(51) Int. Cl. H04M 15/00

(52) U.S. Cl. 379/112.01

(57) ABSTRACT

A method, event information processing system, and wireless communication system capture call/session event information. A series of call/session event information sets (128) is received. Each call/session event information set is classified into one of a normal behavior equivalence category and an abnormal behavior equivalence category. An individual call/session event record (126) is created for each event associated with an abnormal behavior equivalence category. The individual call/session event record (126) is inserted into a call/session event record buffer (124). At least two consecutive call/session events associated with a normal behavior equivalence category are determined to have occurred. A single call/session event record (126) for the at least two consecutive call/session events associated with a normal behavior equivalence category is created. The single call/session event record for the at least two consecutive events associated with a normal behavior equivalence category is inserted into the call/session event record buffer (124).

### FIELD OF THE INVENTION

The present invention generally relates to the field of wireless communications, and more particularly relates to tracking call/session events and managing data associated therewith.

### BACKGROUND OF THE INVENTION

In a traditional circuit switched cellular environment, causal analysis often requires that a statistically significant number of call/session termination events be tracked. Furthermore, to ensure the quality of service expected today by the average subscriber, the ability to rapidly determine the cause of call failure (near-real time) and to make the necessary adjustments in the configuration of the network (in order to prevent further call failures) represents a clear competitive advantage for a communications network operator, such as a cellular or WiMAX carrier. In a next-generation packet based environment, which can be both wired and/or wireless, such as IMS and/or IEEE 802.16, the concept of a call is replaced by the concept of a session. The problem and the competitive advantage provided by the rapid determination and correction of a failure cause remain the same.

Current systems track call/session termination events by storing event information associated with a call (e.g. Call Detail Logs (“CDLs”)) in secondary storage such as hard-drives. With respect to abnormal call termination events (call failures) the analysis performed by current systems is extremely resource intensive. Current systems experience performance and capacity problems because of the large volume of data produced by the average cellular market. Larger markets can produce even more copious volumes of data. Current call failure analysis requires an investment of time and skilled labor that results in the inability to provide near-real time analysis. This is not beneficial for wireless operators since current system analysis methodologies may take a day or more to determine the cause of the failure. This can result in wireless operator revenue loss and poor, undesirable customer experiences.

Therefore a need exists to overcome the problems with the prior art as discussed above.

### SUMMARY OF THE INVENTION

In one embodiment, a method for capturing call/session event information is disclosed. The method includes receiving a series of call/session event information sets. Each call/session event information set in the series of call/session event information sets is classified into one of a normal behavior equivalence category and an abnormal behavior equivalence category. An individual call/session event record is created for each event associated with an abnormal behavior equivalence category. The individual call/session event record is inserted into a call/session event record buffer. At least two consecutive call/session events associated with a normal behavior equivalence category are determined to have occurred. A single call/session event record for the at least two consecutive call/session events associated with a normal behavior equivalence category is created in response to the determining. The single call/session event record for the at least two consecutive events associated with a normal behavior equivalence category is inserted into the call/session event record buffer.

In another embodiment, an event information processing system for capturing call/session event information is disclosed. The event information processing system includes a memory and a processor that is communicatively coupled to the memory. The event information processing system also includes a call/session system that is communicatively adapted to the memory and the processor. The call/session system is adapted to receive a series of call/session event information sets. Each call/session event information set in the series of call/session event information sets is classified into one of a normal behavior equivalence category and an abnormal behavior equivalence category. An individual call/session event record is created for each event associated with an abnormal behavior equivalence category. The individual call/session event record is inserted into a call/session event record buffer. At least two consecutive call/session events associated with a normal behavior equivalence category are determined to have occurred. A single call/session event record for the at least two consecutive call/session events associated with a normal behavior equivalence category is created in response to the determining. The single call/session event record for the at least two consecutive events associated with a normal behavior equivalence category is inserted into the call/session event record buffer.

In yet another embodiment, a wireless communication system for capturing call/session event information is disclosed. The wireless communication system is comprised of a plurality of base stations and a plurality of wireless devices. Each wireless device is communicatively coupled to one of the plurality of base stations. The wireless communication system also includes at least one event information processing system communicatively coupled at least one base station in the plurality of base stations. The event information processing system includes a call/session system that is adapted to receive a series of call/session event information sets. Each call/session event information set in the series of call/session event information sets is classified into one of a normal behavior equivalence category and an abnormal behavior equivalence category. An individual call/session event record is created for each event associated with an abnormal behavior equivalence category. The individual call/session event record is inserted into a call/session event record buffer. At least two consecutive call/session events associated with a normal behavior equivalence category are determined to have occurred. A single call/session event record for the at least two consecutive call/session events associated with a normal behavior equivalence category is created in response to the determining. The single call/session event record for the at least two consecutive events associated with a normal behavior equivalence category is inserted into the call/session event record buffer.

An advantage of the various embodiments of the present invention is that an efficient and beneficial system tracks call/session events in a wireless communication system. For example, in one embodiment of the present invention provides an efficient windowing mechanism that tracks calls/sessions over many events (in order to provide a statistically significant population for analysis) for the purpose of causal analysis of the call/session failures. Call/session event data such as termination event data is monitored so that causes of abnormal call/session terminations can be determined in real-time or near-real time.

This call/session tracking system can be applied to a 2G, 3G, 4G, or any future wireless network regardless of the vendor or equipment within that network. The various embodiments of the present invention result in significantly lower memory (primary and/or secondary) and other resource utilization requirements which, in turn, provides for better scalability when dealing with large numbers of network elements. As such, the call/session tracking system enables the creation of a revenue stream based on a service that can be offered to any wired or wireless networking based communication service provider without regard to the manufacturer of the infrastructure and/or subscribers within the network. Another advantage is that expensive high performance database management systems and associated data mining software are generally not be required.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a wireless communication system according to one embodiment of the present invention;

FIG. 2 illustrates various examples of a call/session event record buffer according to one embodiment of the present invention;

FIGS. 3-6 show additional examples of call/session event record buffer according to other embodiments of the present invention.

FIG. 7 is a block diagram illustrating a detailed view of an event information processing system according to one embodiment of the present invention;

FIG. 8 is an operational flow diagram illustrating an overall process classifying and tracking call/session event information according to one embodiment of the present invention; and

FIG. 9 is an operational flow diagram illustrating an overall process managing call/session event information for a given window according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term “wireless device” is intended to broadly cover many different types of devices that can wirelessly receive signals, and optionally can wirelessly transmit signals, and may also operate in a wireless communication system. For example, and not for any limitation, a wireless communication device can include (but is not limited to) any one or a combination of the following: a two-way radio, a cellular telephone, a mobile phone, a smartphone, a two-way pager, a wireless messaging device, a laptop/computer, automotive gateway, residential gateway, and the like.

It should be noted that the terms “call” and “session” are used interchangeably throughout this discussion. Therefore, although any embodiments directed at a “session” within a next-generation packet based environment are likewise applicable to a “call” within a traditional circuit switched cellular environment and vice versa. Further, the terms and phrases used herein are not intended to be limiting; but rather, to provide an understandable description of the invention.

An Example Of A Wireless Communication System

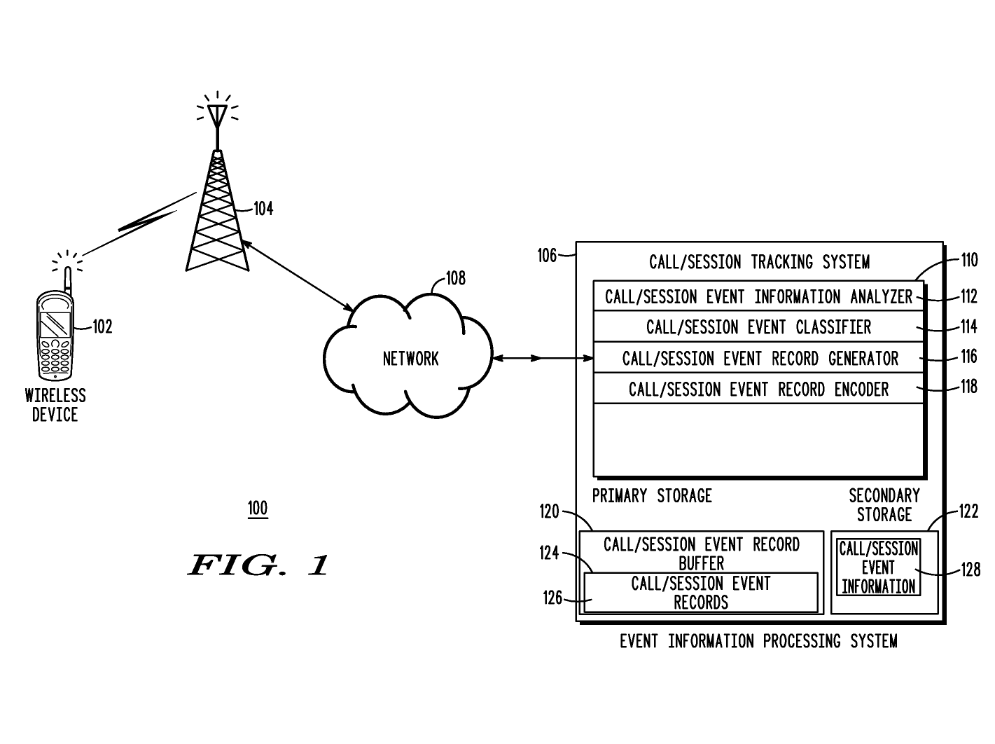

According to an embodiment of the present invention as shown in FIG. 1 a wireless communication system 100 is illustrated. It is assumed that the reader is familiar with the basic infrastructure of wireless communication systems. To simplify the present discussion, only that portion of a wireless communication system relevant to the various embodiments of the present invention is discussed. It should be noted that the various embodiments of the present invention are applicable to any wireless network technology such as (but not limited to) circuit switched networking technologies and packet data networking technologies.

In particular, FIG. 1 shows a system 100 for tracking wireless calls/sessions and the call/session events. The wireless communication system 100 comprises a plurality of wireless devices 102 communicatively coupled to one or more base stations/cells 104. The base station 104 is communicatively coupled to one or more event information processing systems 106 via a network 108. The network 108 can be a wired and/or wireless network. The event information processing system 106, in one embodiment, is an operations and maintenance center comprising a call/session tracking system 110. The call/session tracking system 110, among other things, manages call/session event information, available power during a call/session, and other similar call/session event information. In one embodiment a call/session event can be a call/session initiation event, a call/session termination event, and anything in between. Although some embodiments of the following discussion use call/session terminations as an example of a call/session event, the present invention is not limited to such an embodiment.

In one embodiment, the call/session tracking system 110 comprises a call/session event information analyzer 112, a call/session event classifier 114, an event record generator 116, and a call/session event record encoder 118. The call/session tracking system 110 and its components are discussed in greater detail below. The event information processing system 106 also includes primary storage 120 and secondary storage 122. The primary storage 120 can comprise any type of memory such as (but not limited to) Random Access Memory (“RAM”) used for fast retrieval of data. The secondary storage 122 can comprise any combination of storage devices such as (but not limited to) hard-drives used for data archiving.

In one embodiment, the primary storage 120 includes call/session event record buffers 124 that comprise call/session event records 126. The call/session event record buffers 124 and the call/session event records 126 are discussed in greater detail below. The secondary storage 122, in one embodiment, includes call/session event information 128 associated with a call/session. The call/session 128 event information can be associated with a single wireless device 102 or can be associated with multiple wireless devices. Each instance of call/session event information 128 within the secondary storage 122 corresponds to a particular call/session. The call/session event information 128 can be created from a single message or multiple messages received from a base station controller, wireless device, or other networking component during a call/session. The call/session event information 128, in one embodiment, can identify an originator of a call/session, the server of a call/session, the duration of a call/session, the services used during the call/session, network conditions detected during the call/session, and other related data. In one embodiment, the call/session event information 128 is a call/session detail log/record, but is not limited to such an embodiment.

Managing Call/Session Event Information For Real-Time (Near-Real Time) Causal Analysis

As discussed above, the call/session tracking system 110, among other things, monitors and manages call/session event data associated with received call/session event information 128. One such event is a call/session termination. For example, after a call/session terminates between an originator wireless device 102 and a target device, which can be a wired or wireless device, call/session event information 128 for that call/session is generated. The call/session event information 128 is transmitted by the base station 104, centralized base station controller (not shown), or a network element included within the network 108 to the event information processing system 106 via the network 108.

A call/session termination can typically be classified into N many, two category groupings. For example, a call/session termination can be classified into good/bad voice call/session, good/bad data call/session, normal/abnormal termination, acceptable/unacceptable quality, good/bad data throughput, good/bad quality, and other similar groupings. For the various embodiments of the present invention using a call/session termination as an example of a call/session event, the determination of call/session termination, in one embodiment, can be classified into one of two general categories; abnormal behavior equivalence category or normal behavior equivalence category are used to classify call/session terminations. It should be noted that this is only one example of classifying a call/session termination and does not limit the present invention in any way.

A call/session termination that is classified into an abnormal behavior equivalence category is considered as having failed. Typically, determining the cause of why a call/session terminated normally does not provide any benefit, as normal termination is the expected (and desired) outcome. Within a given cellular network the vast majority of calls/sessions terminate normally (typical “success” percentage for all voice calls is currently around 96%; with approximately 2% RFLOSS failures; and 1.5% access failure with various other failure types). Therefore, the number of calls/sessions that must be tracked in order to provide a sufficient population from which a statistically significant sample of failed calls/sessions can be collected is very large; on the order of somewhere between 10³ and 10⁴ calls and/or sessions for the scope of a single serving entity, such as a base station/cell 104.

Therefore, in one embodiment, the call/session tracking system 110 provides an efficient way to track call/session terminations during a given window such as a window of time or sample window and provides real-time or near real-time analysis of abnormal behavior equivalence category terminated calls/sessions to determine the probable cause of the failure. The call/session tracking system 110, in one embodiment, creates call/session event record buffers 124 in the primary storage 120 associated with the monitored windows for performing the real-time or near real-time analysis discussed above.

For example, when the event information processing system 106 receives call/session event information 128, the call/session event information analyzer 112 analyzes the call/session event information 128 to identify the call/session termination event. The call/session event classifier 114 then classifies the call/session termination as either normal or abnormal based upon the event information included in the call/session event information 128. The call/session event record generator 116 then generates call/session event records 126 based on the determined call/session termination classification. These records 126 can either be encoded or non-encoded where the encoding is performed via the call/session event record encoder 118. The encoding process performed by the call/session event record encoder 118 is discussed in greater detail below. The call/session event record 126 is then inserted into the call/session event record buffer 124.

Call/session terminations classified as normal terminations can be efficiently managed by having the encoder 118 use an encoding mechanism similar but not limited to run-length encoding. For example, the call/session tracking system 110, in one embodiment, tracks normal terminations in blocks using (but not limited to) one or a combination of starting time, time interval, and a count of the number of call/sessions that terminated normally before an abnormal termination. Other combinations exist such as starting time, ending time, and a count or starting database ID and ending database ID as another example. For N number of sequential normal terminations the call/session event record encoder 118 encodes the call/session event information 128 so that the call/session event record generator 116 can create a single record in the call/session event record buffer 124 for a given window. However, the call/session event record generator 116 creates an individual call/session event record 126 for each call/session event information set 128 associated with an abnormal termination that is detected. In other words, call/session event information 128 associated with an abnormal termination is not encoded via the call/session event record encoder 118 as discussed above.

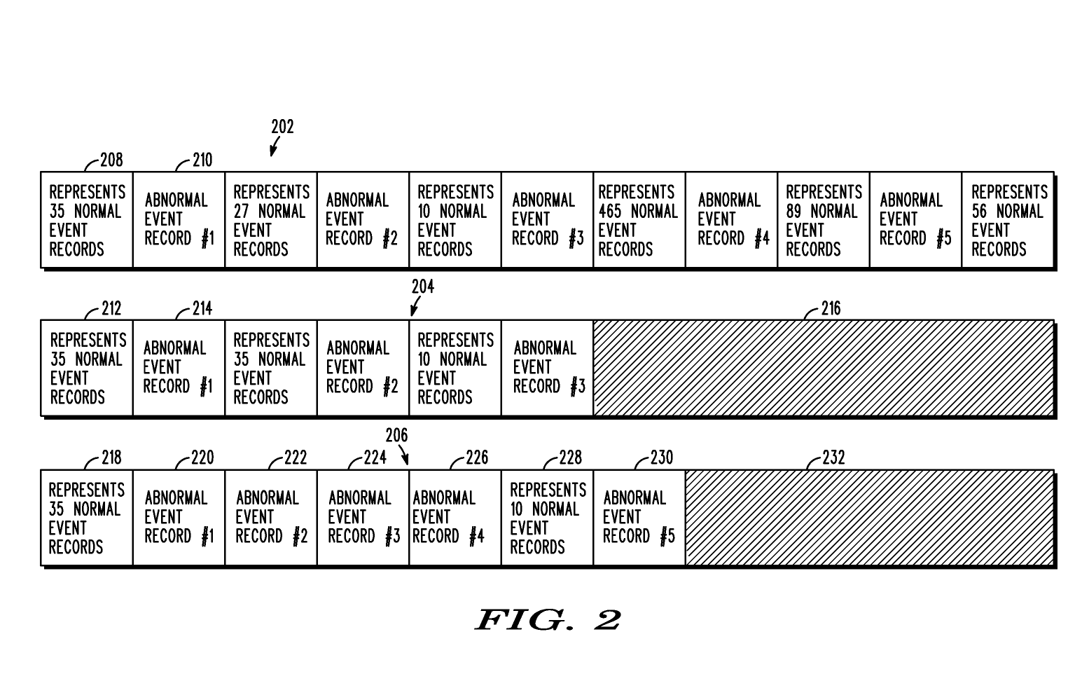

FIG. 2 shows three different examples of the call/session event record buffer 124 of FIG. 1 comprising aggregated call/session event records for normally terminated calls and individual call/session event records for abnormally terminated calls. It should be noted that in one embodiment the call/session event record buffer of FIG. 2 is implemented as a circular buffer of fixed size, however other embodiments such as a list, array, queue, or log are possible. In particular, FIG. 2 shows a first call/session event record buffer 202, a second call/session event record buffer 204, and a third call/session event record buffer 206 all of which are associated with a different window of time.

The first call/session event record buffer 202 is filled with call/session event records. It should be noted that a call/session event record buffer 202 can be of a fixed size or a variable size. A call/session event record buffer 202, in one embodiment, is associated with a performance “window” for each base station/cell 104 in the system 100. It should be appreciated that the performance window may be associated with other managed entities in a communications network. The window is a mechanism by which the call/session tracking system 110 can view a relatively recent performance sample in the assessment of the normality (or abnormality) of the functioning of the base station/cell 104. The length of the window may be constructed to accommodate a percentage of performance class. Alternatively, the window may be constructed to accommodate a time interval over which performance is evaluated. It should be understood that the exact mechanism by which the window is constructed is determined by the overall goals for real-time, or near real-time, failure detection in a communications system.

Each of the call/session event record buffers 202, 204, 206 comprises encoded normal event records and individual abnormal event records such as normal event record 208 and abnormal event record 210. An encoded normal event record such as record 208 can comprise event information such as (but not limited to) a start timestamp indicating when the first normal termination was recorded, an end timestamp indicating when the last normal termination was recorded in a run of normal terminations, the length of a run of normal terminations, the number of normal event records that are encoded within this single record, and a record ID.

The record ID can be a pointer to the location of where the actual call/session event information associated with each of the normal call/session event records within a single encoded normal call/session event record are stored (e.g. database ID). For example, the actual call/session event information can be stored in the secondary storage 122 for further analysis.

It should be noted that the call/session event information can include significant other event information pertinent to determination of the causes for call/session failures. The individual abnormal call/session event records can include event information such as (but not limited to) a record ID and event information required for causal analysis based on the wireless system standard. For example, an abnormal call/session event record can include timestamps, information associated with serving signal strengths; call/session qualities associated with the various parts of the call/session; handoff operations performed within the duration of the call/session; the identities of the pieces of equipment used to serve the call/session during its duration; RF loading information associated with the serving elements for the duration of the call/session; physical capacity measurements or estimations of the associated equipment used for the duration of the call/session; and other information

The record IDs provide the ability to rapidly identify the call/session event information 128 in the database that pertains to a particular window or to a particular event. Identification of normal call/session event information 128 is advantageous because this information can be used as a basis of comparison with information in the abnormal event records in determination of the cause(s) behind the abnormal terminations. The IDs in both window and event cases helps to identify the time interval over which the abnormal terminations occur. Example data from normal terminations can be drawn from the same time window, or example data can be drawn from an entirely different window (for example, a window in which no, or very few, abnormal terminations occur) to provide the basis for comparison.

The first call/session event record buffer 202 shows an alternating sequence of normal call/session event records 208 and abnormal call/session event records 210. In other words, an alternating sequence of consecutive normal call/session terminations then a single abnormal call/session termination occurred. As can be seen by the first encoded normal call/session event record 35 normal call/session terminations occurred before a single abnormal call/session termination occurred as shown by the second call/session event record 210. The 35 normal call/session terminations are represented by a single encoded call/session event record 208. With respect to the second call/session event record buffer 204, a sequence of alternating normal call/session event records 212 and abnormal call/session event records 214 is shown similar to the first call/session event record buffer 202. However, an area 216 representing unfilled portions of the call/session event record buffer 204.

With respect to the third call/session event record buffer 206, a single encoded normal event record 218 representing 35 normal call/session terminations has occurred followed by four individual abnormal call/session event records 220, 222, 224, 226. Another single encoded normal term event record 228 is then inserted into call/session event record buffer 206 representing 10 normal call/session terminations followed by a single abnormal call/session event record 230. The third call/session event record buffer 206 also includes an area 232 of reduced storage call/session termination event information is also shown.

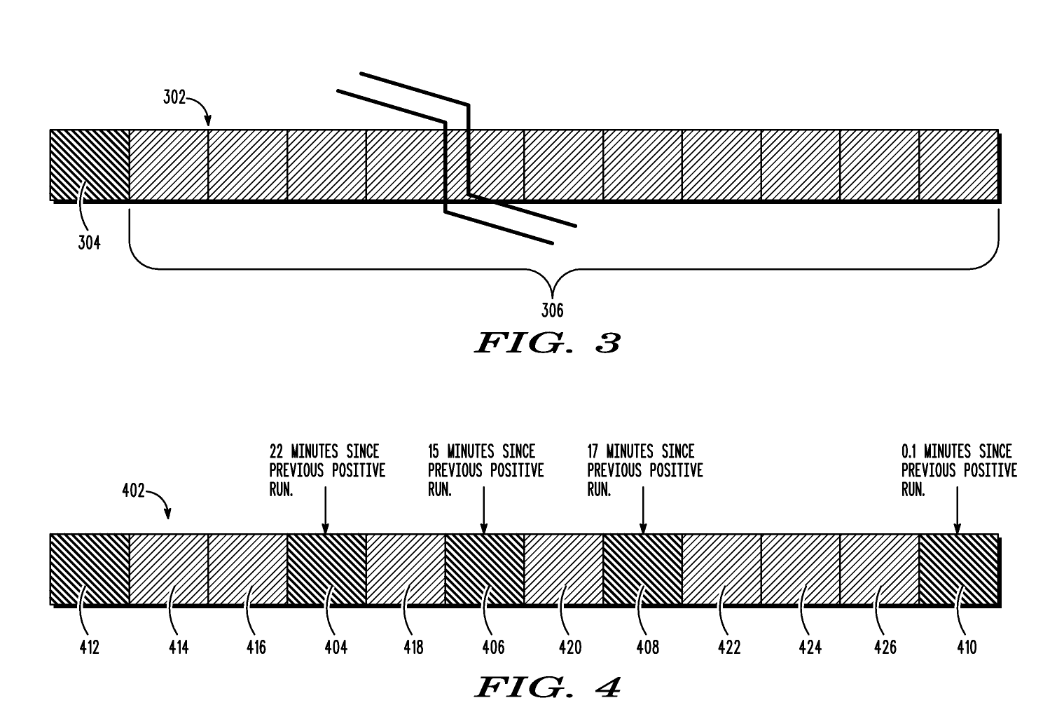

FIGS. 3-6 show additional examples of call/session event record buffers. FIG. 3 shows a call/session event record buffer 302 comprising a single call/session event record 304 associated with a one or more normal terminations and a plurality 306 of individual call/session event records associated with abnormal terminations. In one embodiment, the normal call/session event record 302 is time stamped to indicate the beginning and end of the normal call/session termination run. For example, if the normal call/session event record 302 comprises 30 normal call/session terminations a time stamp indicates when the first normal termination occurred and when the last normal termination occurred. It should be noted that a time stamp is not required and other information such (but not limited to) as starting database ID and ending database ID information can also be included.

As discussed above a call/session event record buffer is used to monitor call/session terminations over a particular window. In the example of FIG. 3 when a windowing threshold (based on time and/or when a number of call/session terminations have occurred) has been exceeded, the call/session event information 128 associated with the normal call/session terminations are extracted from the secondary storage 122. The features common to the normal call/session terminations are then extracted from the call/session information 128 and compared with the abnormal call/session termination data associated with the plurality 306 of individual abnormal call/session event records.

FIG. 4 shows another call/session event record buffer 402 comprising a plurality of normal and abnormal call/session event records. In particular, the call/session event record buffer 402 includes a plurality of encoded normal call/session event records 404, 406, 408, 410, 412 each comprising a time stamp indicating a start time and end time of the normal run. In the example of FIG. 4 each of the encoded normal call/session event records 404, 406, 408, 410, 412 include large numbers (10's to 100's) of normal call/session event records.

Also, each of the encoded normal call/session event records 404, 406, 408, 410, 412 indicates how much time has elapsed since the previous normal call/session event record or encoding of a run of normal call/session event records. For example, the encoded normal call/session event record 404 indicates that 22 minutes have passed since the last normal call/session termination run (i.e. encoded normal call/session event record 412). Each individual abnormal call/session event record 414-426 also includes a time stamp. The time stamps can be used for identifying and analyzing correlated failure runs. The call/session event information 128 associated with each of the abnormal call/session event records 414-426 can be retrieved to extract features common to the abnormal call/session terminations.

FIG. 5 shows a call/session event record buffer 502 also comprising a plurality of encoded normal call/session event records and abnormal call/session event records. Similar to the call/session event record buffer 402 of FIG. 4, where the encoded normal event records 504-512 indicate how much time has elapsed since the previous normal call/session event record run. However, FIG. 5 shows the interval being constant, e.g., every 3 minutes. Therefore, the call/session tracking system 110 detects a constant interval and increments a periodicity detector count. When the periodicity detector count reaches a threshold, the abnormal event records 514-526 are analyzed. For each abnormal event record analyzed the adjacent normal event records are retrieved using the time stamp information and are also analyzed. This allows for any correlation between the abnormal terminations and normal terminations to be observed.

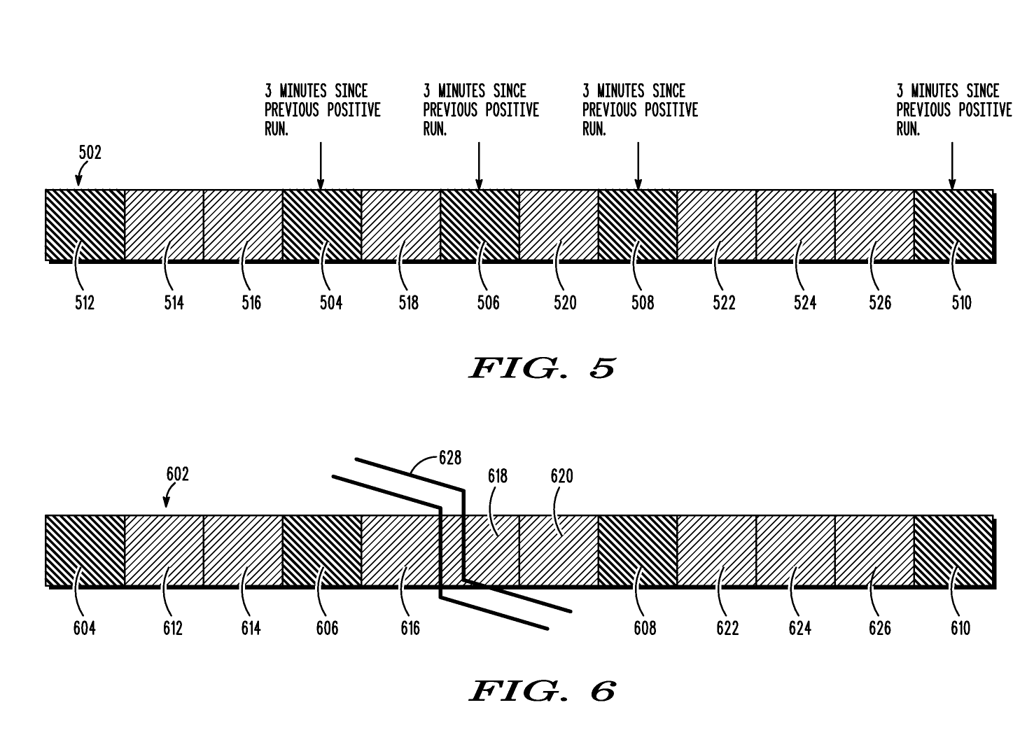

FIG. 6 shows a call/session event record buffer 602 also comprising a plurality of encoded normal call/session event records 604-610 and a plurality of abnormal call/session event records 612-626. In the example of FIG. 6, the call/session tracking system 110 analyzes the plurality of encoded normal call/session event records 604-610 and their respective time stamps to bound regime change activity. The call/session tracking system 110 detects a change point or regime change 628 in system performance statistics or other measure. The regime change is useful, as it provides the call/session tracking system 110 with yet another device by which to partition normal and abnormal termination behavior in the system 100. Noting these partition occurrences, and recording their residence in the database, allows additional causal analysis to be performed.

As can be seen from the above discussion, normal call/session terminations are aggregated into a single encoded normal call/session event record until an abnormal call/session termination occurs. An individual abnormal call/session event record is then inserted into the call/session event record buffer for the single abnormal call/session termination. This method is advantageous because data of lesser importance (the normal call/session termination data) is reduced, thereby minimizing storage space required in primary storage 120. The call/session event records within the primary storage can be analyzed for real-time or near real-time analysis for determining probable causes of abnormal terminations. Additionally, raw data can be stored in secondary storage 122 for further analysis.

Event Information Processing System

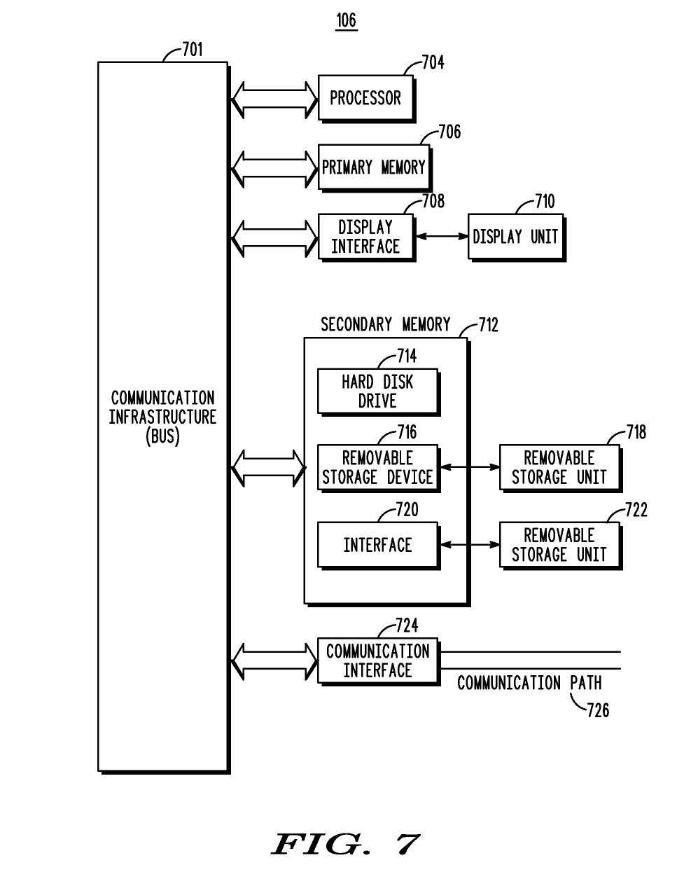

FIG. 7 is a high level block diagram illustrating a detailed view of an event information processing system 106. The event information processing system 106 is based upon a suitably configured processing system adapted to implement an exemplary embodiment of the present invention. For example, a personal computer, workstation, or the like, may be used.

In one embodiment of the present invention, the event information processing system 106 includes one or more processors, such as processor 704. The processor 704 is connected to a communication infrastructure 701 (e.g., a communications bus, crossover bar, or network). Various software embodiments are described in terms of this exemplary computer system. After reading this discussion, it is apparent to a person of ordinary skill in the relevant art(s) how to implement the invention using other computer systems and/or computer architectures.

The event information processing system 106 can include a display interface 708 that forwards graphics, text, and other data from the communication infrastructure 701 (or from a frame buffer) for display on the display unit 710. The event information processing system 106 also includes primary memory 706, preferably random access memory (RAM), and may also include a secondary memory 712 as well as various caches and auxiliary memory as are normally found in computer systems. The primary memory 120 and secondary memory 122 have been discussed above in greater detail. The secondary memory 712 may include, for example, a hard disk drive 714 and/or a removable storage device 716, representing a floppy disk drive, a magnetic tape drive, an optical disk drive, and other removable media. The removable storage device 716 reads from and/or writes to a removable storage unit 718 in a manner well known to those having ordinary skill in the art.

The removable storage unit 718 represents a floppy disk, a compact disc, magnetic tape, optical disk, and other removable media which is read by and written to by removable storage drive 716. As are appreciated, the removable storage unit 718 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 712 may include other similar means for allowing computer programs or other instructions to be loaded into the event information processing system 106. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the event information processing system 106.

The event information processing system 106, in this example, includes a communications interface 724 that acts as an input and output and allows software and data to be transferred between the event information processing system 106 and external devices or access points via a communications path 726. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. The signals are provided to communications interface 724 via a communications path (i.e., channel) 726. The channel 726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as primary memory 706 and secondary memory 712, removable storage device 716, a hard disk installed in hard disk drive 714, and signals. The computer program products are means for providing software to the computer system. The computer readable medium allows the computer system to read data, instructions, messages or message packets, and other computer readable information from the computer readable medium.

Computer programs (also called computer control logic) are stored in primary memory 706 and/or secondary memory 712. Computer programs may also be received via communications interface 724. Such computer programs, when executed, enable the computer system to perform the features of the various embodiments of the present invention as discussed herein. In particular, the computer programs, when executed, enable the processor 704 to perform the features of the computer system.

Process For Classifying and Tracking Calls/Sessions

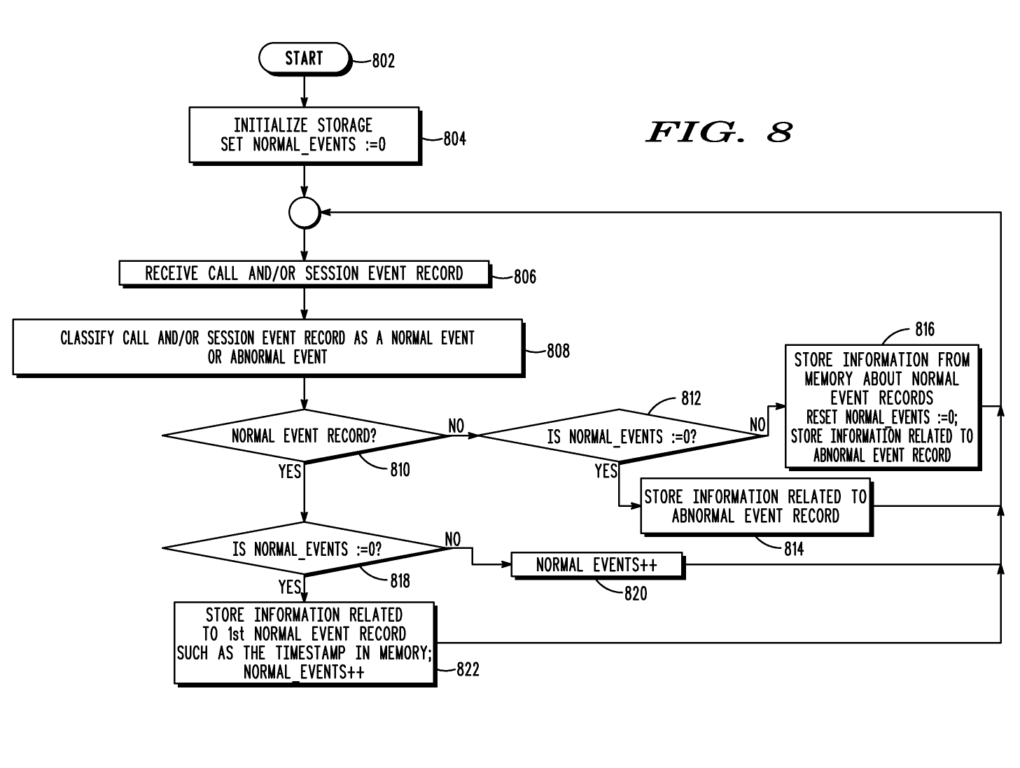

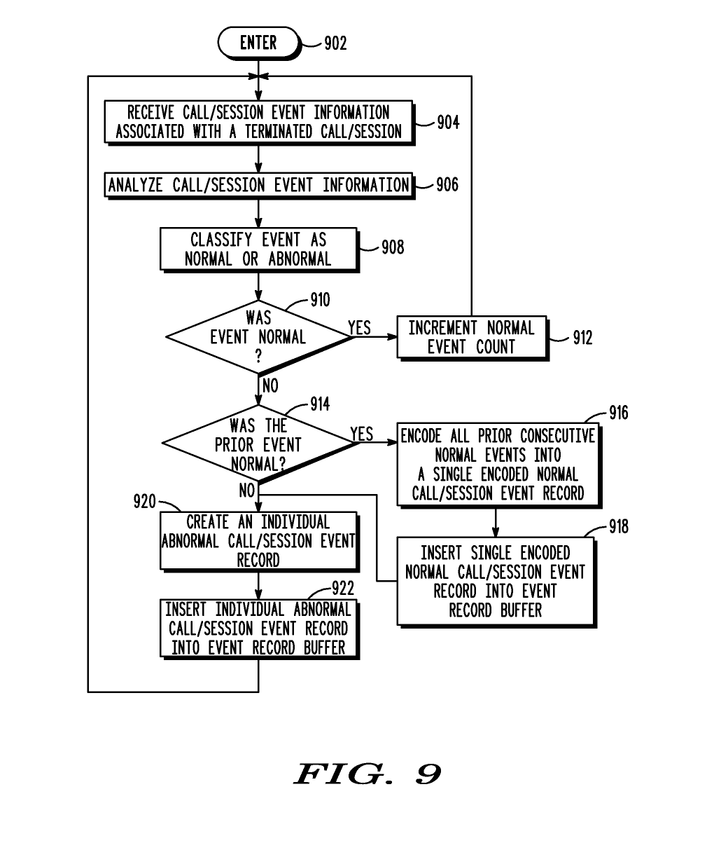

FIG. 8 is an operational diagram illustrating an overall process classifying and tracking call/session event records. The operational diagram of FIG. 8 begins at step 802 and flows directly to step 804. The call/session tracking system 110, at step 804, initializes the primary storage 120 and sets the normal events equal to 0. The call/session tracking system 110, at step 806, receives a call/session event record 126. The call/session event record 126, at step 808, is classified as a normal event (e.g., classified into a normal behavior equivalence category) or an abnormal event (e.g., classified into an abnormal behavior equivalence category). The call/session tracking system 110, at step 810, determines if the event record 126 has been classified as a normal event record. If the result of this determination is positive, the control flows to step 818. If the result of this determination is negative, the call/session tracking system 110, at step 812, determines if the number of normal events with a for the current call/session event information set is equal to 0.

If the result of this determination is positive, the call/session tracking system 110, at step 814, stores information related to abnormal event record such as time stamp, database ID, and other types of information discussed above. The control flow returns to step 806. If the result of the determination at step 812, is negative, the call/session tracking system 110, at step 816, stores information to the primary storage 120 associated with normal event records such as (but not limited to) time stamp of the first normal event record; number of normal event records received since the first received normal event record; length of time elapsed between the first and last normal event records; the end time of the last normal event record; record IDs and other types of information. The call/session tracking system 110 also resets the normal event count to 0 and stores information related to the abnormal event record such as time stamp, database ID, and other types of information. The control flow returns to step 806.

As discussed above, if the result of step 810 is positive the control flows to step 818 where the call/session tracking system 110 determines if the normal event count is equal to 0. If the result of this determination is negative, the call/session tracking system 110, at step 820, increments the normal event count. The control flow then returns to step 806. If the result of this determination is positive, the call/session tracking system 110, at step 822 stores information related to the first normal event record such as the time stamp in the primary storage 120. The call/session tracking system 110 also increments the normal event count. The control flow then returns to step 806.

Process For Managing Call/Session Events

FIG. 9 is an operational diagram illustrating an overall process managing call/session events for a given window. The operational diagram of FIG. 9 begins at step 902 and flows directly to step 904. It should be noted that the following process is repeated until a current window of time being monitored expires or a given number of call/session event records 124 (e.g., call/session event records) have been generated. The call/session tracking system 110, at step 904, receives a series of call/session event information sets 128. A call/session event information sets can include a single call/session event information 126 or multiple call/session information 126. The call/session tracking system 110, at step, 906, analyzes the call/session event information 128. The call/session event such as a call/session termination associated with the call/session event information 128, at step 908, is classified as either normal or abnormal. The call/session tracking system 110, at step 910, determines if the event was classified as normal. If the result of this determination is positive, a normal event count is incremented. The control flow then returns to step 904.

If the result of the determination at step 910 is negative, the call/session tracking system 110, at step 914, determines if a prior event (if any) was normal. If the result of this determination is positive, the call/session tracking system 110, at step 916, encodes, via the call/session event record encoder 118, all of the prior consecutive normal call/session events into a single encoded normal call/session event record. The call/session tracking system 110, at step 918, inserts the single encoded normal call/session event record into a call/session event record buffer 124 associated with the window. The control then flows to step 920. If the result of the determination at step 914 is negative, an individual abnormal call/session event record, at step 920, is created for the abnormal event. The call/session tracking system 110, at step 922, inserts the individual abnormal call/session event record into the call/session event record buffer 124 associated with the window being monitored. The control flow then returns to step 904.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method on an event information processing system for capturing call/session event information the method comprising:
receiving a series of call/session event information sets:
classifying each call/session event information set in the series of call/session event information sets into one of a normal behavior equivalence category and an abnormal behavior equivalence category;
creating an individual call/session event record for each event associated with an abnormal behavior equivalence category;
inserting the individual call/session event record into a call/session event record buffer;
determining that at least two consecutive call/session events associated with a normal behavior equivalence category have occurred;
creating, in response to the determining, a single call/session event record for the at least two consecutive call/session events associated with a normal behavior equivalence category; and
inserting the single call/session event record for the at least two consecutive events associated with a normal behavior equivalence category into the call/session event record buffer.

2. The method of claim 1, wherein the call/session event record buffer comprises call/session event records for a given period of time.

3. The method of claim 1, wherein the call/session event record buffer comprises one of a fixed number of call/session event records and a variable number of call/session event records.

4. The method of claim 1, further comprising:
storing the call/session event record buffer in a primary storage; and
storing the series of call/session event information sets in a secondary storage.

5. The method of claim 1, wherein the individual call/session event record comprises a pointer to a corresponding call/session event information stored in a secondary storage.

6. The method of claim 1, wherein the individual call/session event record for each call/session event associated with an abnormal behavior equivalence category and the single encoded event record for the at least two consecutive call/session events associated with a normal behavior equivalence category comprise at least a time stamp indicating when at least one of an event associated with a normal behavior equivalence category and event associated with an abnormal behavior equivalence category occurred, respectively.

7. The method of claim 1, wherein the single encoded call/session event record for the at least two consecutive call/session events associated with a normal behavior equivalence category comprises call/session event information indicating how much time has elapsed since a last encoded call/session event record for at least two consecutive call/session events associated with a normal behavior equivalence category.

8. An event information processing system for capturing call/session event information, the event information processing system comprising:
a memory;
a processor communicatively coupled to the memory; and
a call/session tracking system communicatively coupled to the memory and the processor, wherein the call/session system is adapted to:
receive a series of call/session event information sets:
classify each call/session event information set in the series of call/session event information sets into one of a normal behavior equivalence category and an abnormal behavior equivalence category;
create an individual call/session event record for each event associated with an abnormal behavior equivalence category;
insert the individual call/session event record into a call/session event record buffer;
determine that at least two consecutive call/session events associated with a normal behavior equivalence category have occurred;
create, in response to at least two consecutive call/session events associated with a normal behavior equivalence category having occurred, a single call/session event record for the at least two consecutive call/session events associated with a normal behavior equivalence category; and
insert the single call/session event record for the at least two consecutive events associated with a normal behavior equivalence category into the call/session event record buffer.

9. The event information processing system of claim 8, wherein the call/session event record buffer comprises call/session event records for a given period of time.

10. The event information processing system of claim 8, wherein the call/session event record buffer comprises one of a fixed number of call/session event records and a variable number of call/session event records.

11. The event information processing system of claim 8, wherein the call/session tracking system is further adapted to:
store the call/session event record buffer in a primary storage; and
store the series of call/session event information sets in a secondary storage.

12. The event information processing system of claim 8, wherein the individual call/session event record comprises a pointer to a corresponding call/session event information stored in a secondary storage.

13. The event information processing system of claim 8, wherein the individual call/session event record for each call/session event associated with an abnormal behavior equivalence category and the single encoded event record for the at least two consecutive call/session events associated with a normal behavior equivalence category comprise at least a time stamp indicating when at least one of an event associated with a normal behavior equivalence category and event associated with an abnormal behavior equivalence category occurred, respectively.

14. The event information processing system of claim 8, wherein the single encoded call/session event record for the at least two consecutive call/session events associated with a normal behavior equivalence category comprises call/session event information indicating how much time has elapsed since a last encoded call/session event record for at least two consecutive call/session events associated with a normal behavior equivalence category.

15. A wireless communication system for capturing call/session event information, the wireless communication system, comprising:
a plurality of base stations;
a plurality of wireless devices, wherein at least one of the wireless devices is communicatively coupled to one of the plurality of base stations; and
a least one event information processing system communicatively coupled to at least one of the base stations, wherein the event information processing system includes
a call/session tracking system adapted to:
receive a series of call/session event information sets:
classify each call/session event information set in the series of call/session event information sets into one of a normal behavior equivalence category and an abnormal behavior equivalence category;
create an individual call/session event record for each event associated with an abnormal behavior equivalence category;
insert the individual call/session event record into a call/session event record buffer;
determine that at least two consecutive call/session events associated with a normal behavior equivalence category have occurred;
create, in response at least two consecutive call/session events associated with a normal behavior equivalence category having occurred, a single call/session event record for the at least two consecutive call/session events associated with a normal behavior equivalence category; and
insert the single call/session event record for the at least two consecutive events associated with a normal behavior equivalence category into the call/session event record buffer.

16. The wireless communication system of claim 15, wherein the call/session event record buffer comprises one of a fixed number of call/session event records and a variable number of call/session event records

17. The wireless communication system of claim 15, wherein the call/session tracking system is further adapted to:
store the call/session event record buffer in a primary storage; and
store the series of call/session event information sets in a secondary storage.

18. The wireless communication system of claim 15, wherein the individual call/session event record comprises a pointer to a corresponding call/session event information stored in a secondary storage.

19. The wireless communication system of claim 15, wherein the individual call/session event record for each call/session event associated with an abnormal behavior equivalence category and the single encoded event record for the at least two consecutive call/session events associated with a normal behavior equivalence category comprise at least a time stamp indicating when at least one of an event associated with a normal behavior equivalence category and event associated with an abnormal behavior equivalence category occurred, respectively.

20. The wireless communication system of claim 15, wherein the single encoded call/session event record for the at least two consecutive call/session events associated with a normal behavior equivalence category comprises call/session event information indicating how much time has elapsed since a last encoded call/session event record for at least two consecutive call/session events associated with a normal behavior equivalence category.
